(19) United States
(12) Patent Application Publication
(10) Pub. No.: US 2015/0059131 A1
(43) Pub. Date: Mar. 5, 2015

(54) Fixing Structure for Rope

(71) Applicant: Cheng-Li Wu, Tianzhong Township (TW)

(72) Inventor: Cheng-Li Wu, Tianzhong Township (TW)

(21) Appl. No.: 14/010,594

(22) Filed: Aug. 27, 2013

(51) Int. Cl. F16G 11/04

(52) U.S. Cl. CPC F16G 11/04
USPC 24/128

(57) ABSTRACT

A fixing structure for a rope is applied to adjust and position a rope for fixing an object and contains a body including a connecting unit and a guiding unit coupled with one end of the connecting unit. The connecting unit has a through hole defined therein so as to insert one of two inserting ends of the rope. The guiding unit has an extension member and at least one support arm for matching with the extension member, wherein a defining space is open and is defined between the extension member and the at least one support arm so as to position a tied portion on the other of the two inserting ends of the rope, such that one of the two inserting ends is fixed in the connecting unit, and the tied portion is fitted and engaged with the limiting end of the defining space, thus positioning the rope.

### FIELD OF THE INVENTION

The present invent relates to a fixing structure which is applied to adjust and position a rope for fixing an object.

### BACKGROUND OF THE INVENTION

A conventional fixing structure for a rope is used to adjust and position the rope for fixing an object.

The rope has two ends, and each or two ends are tied to form one or two tied portions, but each tied portion lessens easily, so the rope cannot be fixed securely. To solve such a problem, an improved fixing structure has been developed. For example, the fixing structure contains a seat, a resilient element, and a pressing member. The seat has a receiving groove defined therein and a through hole passing through the receiving groove. The resilient element is mounted in the receiving groove by ways of the pressing member, and the pressing member has a retaining fringe defined on a bottom end thereof, such that the pressing member is fixed in the receiving groove so that the retaining fringe retains with the through hole. The pressing member also has a chamber so that when it is pushed by the resilient element to move outwardly, the retaining fringe is fixed, and when the pressing member is forced, the chamber of the pressing member aligns with the through hole, and when the pressing member is unforced, it is pushed outwardly. It is to be noted that after pressing the pressing member, the chamber aligns with the through hole so as to insert the rope into the fixing structure via the chamber, thus moving the fixing structure to any desired portion on the rope. After the pressing member is unforced, a shear force produces between the pressing member and the seat, hence the rope is fixed between the through hole and the chamber. However, the rope cannot be fixed securely.

The present invention has arisen to mitigate and/or obviate the afore-described disadvantages.

### SUMMARY OF THE INVENTION

The primary object of the present invention is to provide a fixing structure which is applied to adjust and position a rope for fixing an object.

To obtain the above objectives, a fixing structure contains: a body including a connecting unit and a guiding unit coupled with one end of the connecting unit.

The connecting unit has a through hole defined therein so as to insert one of two inserting ends of the rope.

The guiding unit has an extension member and at least one support arm for matching with the extension member, wherein a defining space is open and is defined between the extension member and the at least one support arm so as to position a tied portion on the other of the two inserting ends of the rope, such that one of the two inserting ends is fixed in the connecting unit, and the tied portion is fitted and engaged with the limiting end of the defining space, thus positioning the rope.

### BRIEF DESCRIPTION OF THE DRAWINGS

FIG. 1 is a perspective view showing the assembly of a fixing structure for a rope according to a first embodiment of the present invention.

FIG. 2 is a perspective view showing the operation of the fixing structure for the rope according to the first embodiment of the present invention.

FIG. 3 is another perspective view showing the operation of the fixing structure for the rope according to the first embodiment of the present invention.

FIG. 4 is also another perspective view showing the operation of the fixing structure for the rope according to the first embodiment of the present invention.

FIG. 5 is a perspective view showing the assembly and the operation of a fixing structure for a rope according to a second embodiment of the present invention.

FIG. 6 is another perspective view showing the assembly and the operation of the fixing structure for the rope according to the second embodiment of the present invention.

FIG. 7 is a perspective view showing the assembly and the operation of a fixing structure for a rope according to a third embodiment of the present invention.

FIG. 8 is another perspective view showing the assembly and the operation of the fixing structure for the rope according to the third embodiment of the present invention.

### DETAILED DESCRIPTION OF THE PREFERRED EMBODIMENTS

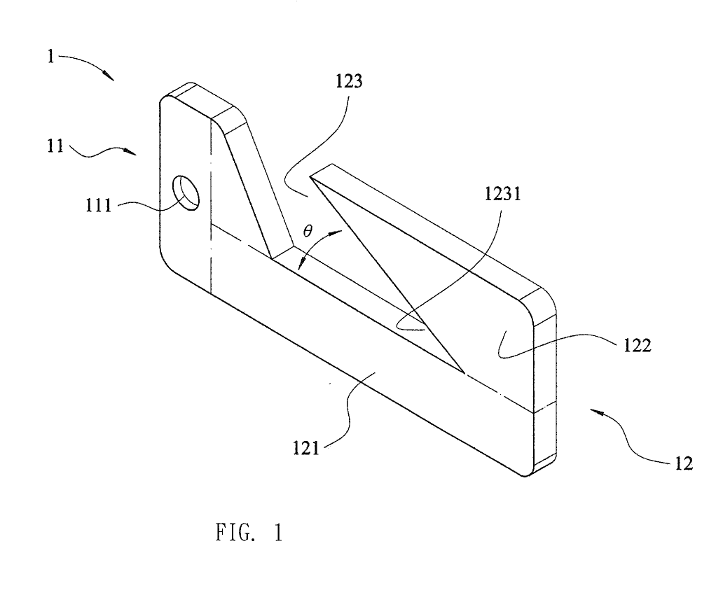

With reference to FIG. 1, a fixing structure for a rope according to a first embodiment of the present invention comprises: a body 1 including a connecting unit 11 and a guiding unit 12 coupled with one end of the connecting unit 11. The connecting unit 11 has a through hole 111 defined thereon. The guiding unit 12 has an extension member 121 and a support arm 122 for matching with the extension member 121, wherein a defining space 123 is open and is defined between the extension member 121 and the support arm 122, wherein the defining space 123 has a limiting end 1231 defined between the extension member 121 and the support arm 122, and the limiting end 1231 has an angle θ formed therein. It is to be noted that the body 1 is made of any one of iron material, plastic material, acrylic material and other rigid material, etc. In assembly, the connecting unit 11 and the guiding unit 12 of the body 1 are one piece formed or connected together, and the extension member 121 and the support arm 122 of the guiding unit 12 are one piece formed or connected together, thus assembling the body 1 of the fixing structure.

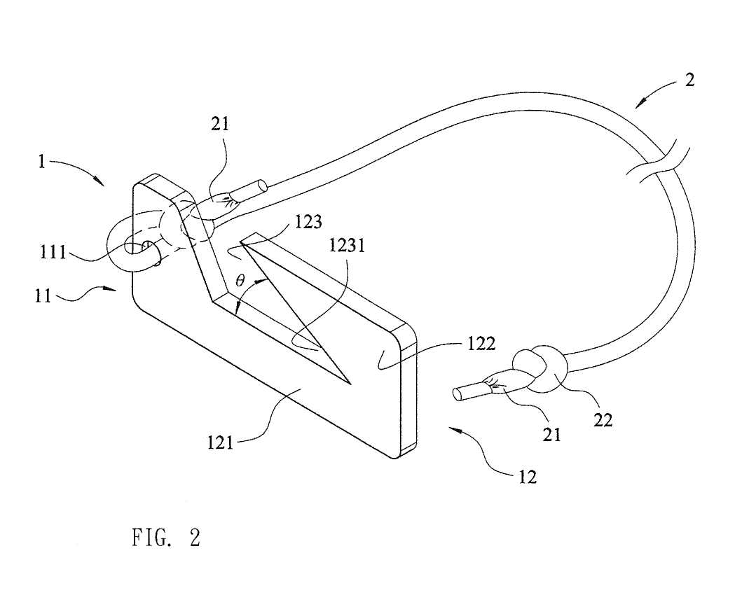

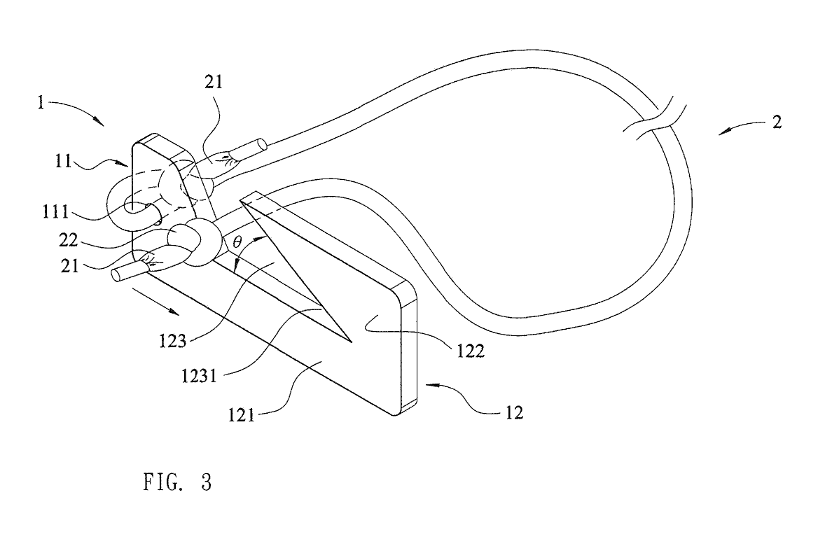

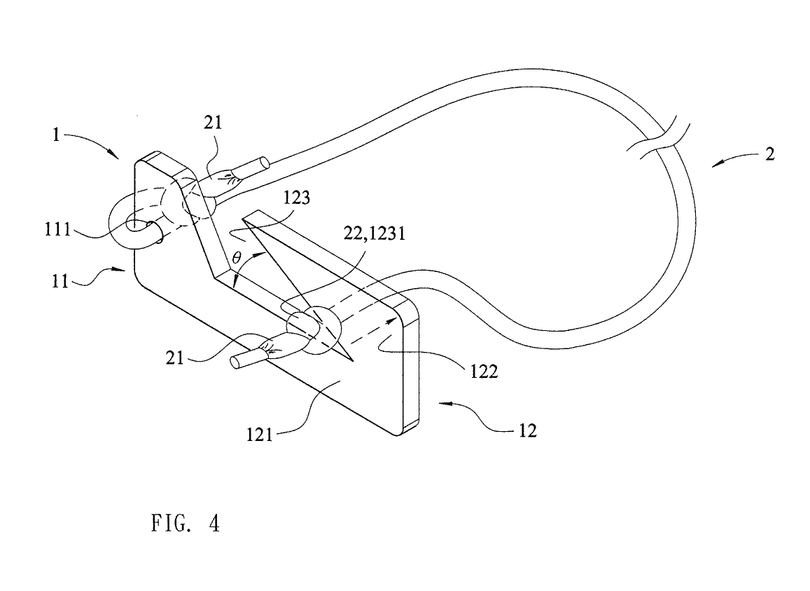

Referring further to FIGS. 2 to 4, the body 1 of the fixing structure is applied to adjust and position a rope 2 for fixing an object, wherein the body 1 includes the connecting unit 11 and the guiding unit 12, and the through hole 111 of the connecting unit 11 is used to insert one of two inserting ends 21 of the rope 2. The support arm 122 of the guiding unit 12 is served to match with the extension member 121, and a tied portion 22 on the other of the two inserting ends 21 of the rope 2 is fitted into the defining space 123, wherein the defining space 123 is formed in any one shape of a circle, a triangle, a square, a rhombus and a polygon. The angle θ of the limiting end 1231 of the defining space 123 is within 0 degree to 45 degrees, such that one of the two inserting ends 21 of the rope 2 is inserted through the through hole 111 and is fixed in the connecting unit 11, and the tied portion 22 on the other of the two inserting ends 21 of the rope 2 is fitted and engaged with the limiting end 1231 of the defining space 123, thus positioning the rope 2. On the contrary, the tied portion 22 on the other of the two inserting ends 21 of the rope 2 is disengaged from the limiting end 1231 of the defining space 123, thus removing the rope 2.

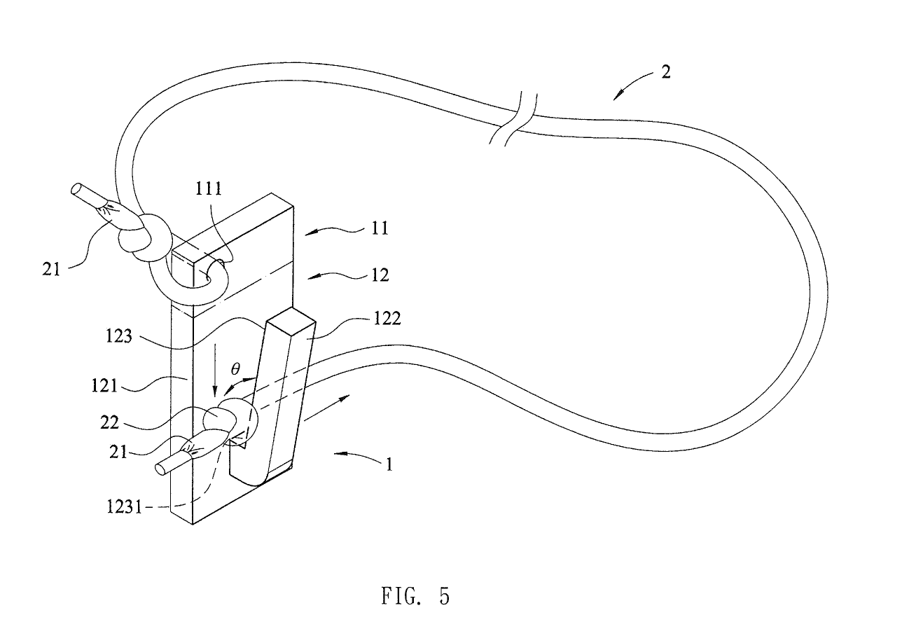

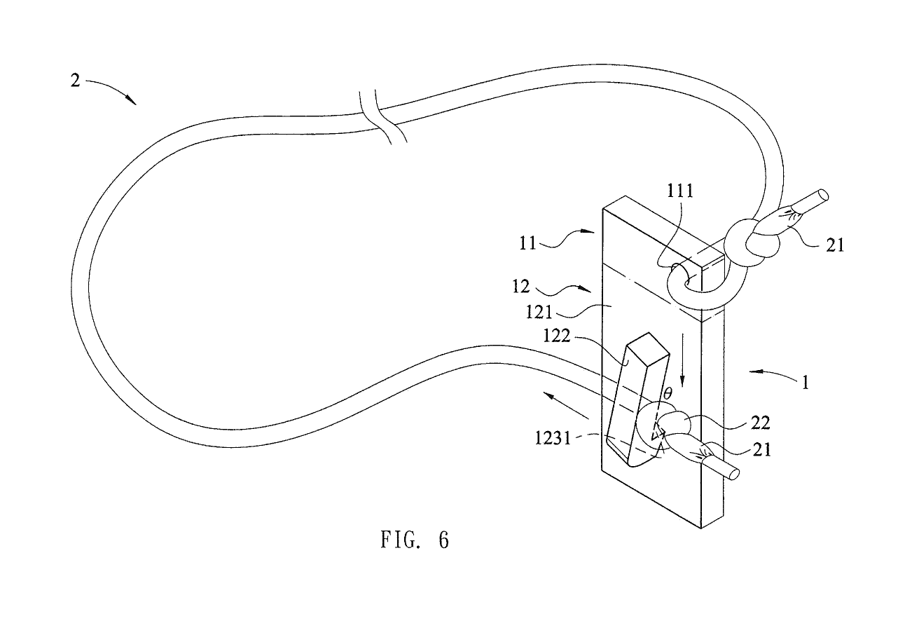

As shown in FIGS. 5 and 6, a fixing structure for a rope according to a second embodiment of the present invention comprises: a body 1 including a connecting unit 11 and a guiding unit 12 coupled with one end of the connecting unit 11. The connecting unit 11 has a through hole 111 defined thereon. The guiding unit 12 has an extension member 121 and a support arm 122 for matching with the extension member 121, and wherein a bottom surface of the support arm 122 is tilted to a top surface of the extension member 121 as shown in FIG. 5; or the bottom surface of the support arm 122 of the guiding unit 12 is parallel to the top surface of the extension member 121 as shown in FIG. 6. Furthermore, the support arm 122 is formed in a L shape, and between the support arm 122 and the extension member 121 is defined a defining space 123 which is open; wherein the defining space 123 has a limiting end 1231 defined between the extension member 121 and the support arm 122, and the limiting end 1231 has an angle θ formed therein, wherein the angle θ of the limiting end 1231 of the defining space 123 is within 0 degree to 45 degrees, such that one of two inserting ends 21 of a rope 2 is inserted through the through hole 111 and is fixed in the connecting unit 11. It is to be noted that a distance between the bottom surface of the support arm 122 and the top surface of the extension member 121 is less than a thickness of a tied portion 22 on the other of the two inserting ends 21 of the rope 2, such that one of the two inserting ends of the rope 2 is fixed in the connecting unit 11, and the tied portion 22 on the other of the two inserting ends 21 of the rope 2 is fitted and engaged with the limiting end 1231 of the defining space 123, thus positioning the rope 2. On the contrary, the tied portion 22 on the other of the two inserting ends 21 of the rope 2 is disengaged from the limiting end 1231 of the defining space 123, thus removing the rope 2.

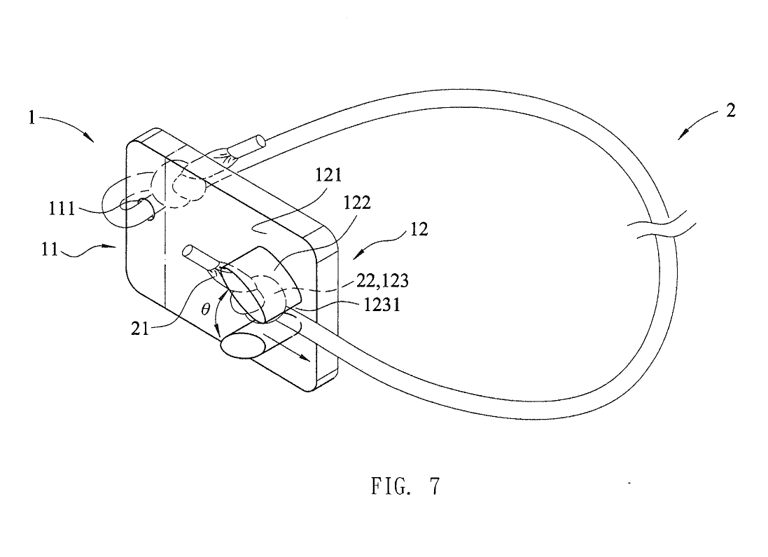

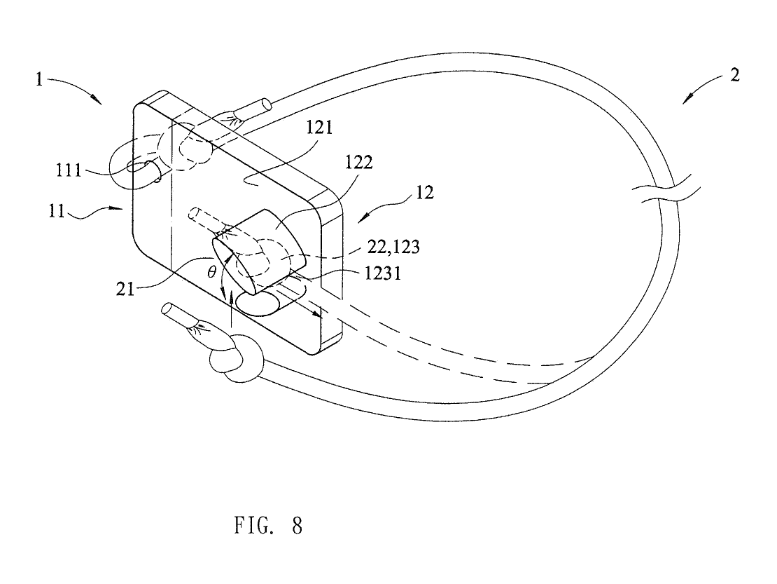

As illustrated in FIGS. 7 and 8, a fixing structure for a rope according to a third embodiment of the present invention comprises: a body 1 including a connecting unit 11 and a guiding unit 12 coupled with one end of the connecting unit 11. The guiding unit 12 has an extension member 121 and at least one support arm 122 for matching with the extension member 121, wherein a defining space 123 is open and is defined among the extension member 121 and two of the at least one support arm 122, wherein the defining space 123 has a limiting end 1231, and the limiting end 1231 has an angle θ formed therein. Moreover, heights of the two of the at least one support arm 122 of the guiding unit 12 are identical (as shown in FIG. 7) or different (as shown in FIG. 8), and wherein the angle θ of the limiting end 1231 of the defining space 123 is within 0 degree to 45 degrees. It is to be noted that a width of the limiting end 1231 of the defining space 123 is less than a thickness of a tied portion 22 on the other of the two inserting ends 21 of the rope 2, such that one of the two inserting ends of the rope 2 is fixed in the connecting unit 11, and the tied portion 22 on the other of the two inserting ends 21 of the rope 2 is fitted and engaged with the limiting end 1231 of the defining space 123, thus positioning the rope 2. On the contrary, the tied portion 22 on the other of the two inserting ends 21 of the rope 2 is disengaged from the limiting end 1231 of the defining space 123, thus removing the rope 2.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A fixing structure for a rope being applied to adjust and position a rope for fixing an object and comprising a body, the body including a connecting unit and a guiding unit coupled with one end of the connecting unit; the connecting unit having a through hole defined therein so as to insert one of two inserting ends of the rope; the guiding unit having an extension member and at least one support arm for matching with the extension member, wherein a defining space is open and is defined between the extension member and the at least one support arm so as to position a tied portion on the other of the two inserting ends of the rope.

2. The fixing structure for the rope as claimed in claim 1, wherein the defining space has a limiting end defined between the extension member and the at least one support arm, and the limiting end has an angle formed therein, the angle of the limiting end is within 0 degree to 45 degrees, such that one of the two inserting ends of the rope is inserted through the through hole and is fixed in the connecting unit, and the tied portion on the other of the two inserting ends of the rope is fitted and engaged with the limiting end of the defining space; wherein a distance between a bottom surface of the at least one support arm and a top surface of the extension member is less than a thickness of the tied portion on the other of the two inserting ends of the rope.

3. The fixing structure for the rope as claimed in claim 2, wherein the bottom surface of the at least one support arm is tilted to the top surface of the extension member, and the extension member and the at least one support arm are assembled by selecting from one piece forming and connecting.

4. The fixing structure for the rope as claimed in claim 2, wherein the bottom surface of the at least one support arm is parallel to the top surface of the extension member, and the extension member and the at least one support arm are assembled by selecting from one piece forming and connecting.

5. The fixing structure for the rope as claimed in claim 1, wherein the defining space is defined among the extension member and two of the at least one support arm, and heights of the two of the at least one support arm are identical.

6. The fixing structure for the rope as claimed in claim 1, wherein the defining space is defined among the extension member and two of the at least one support arm, and heights of the two of the at least one support arm are different.

7. The fixing structure for the rope as claimed in claim 1, wherein the connecting unit and the guiding unit of the body are assembled by selecting from one piece forming and connecting.
